(19) United States
(12) Patent Application Publication
(10) Pub. No.: US 2022/0148536 A1
(43) Pub. Date: May 12, 2022

(54) Minimizing Display Flickering During Biometric Authentication

(71) Applicant: Google LLC, Mountain View, CA (US)

(72) Inventor: Sangmoo Choi, Palo Alto, CA (US)

(73) Assignee: Google LLC, Mountain View, CA (US)

(21) Appl. No.: 17/586,386

(22) Filed: Jan. 27, 2022

Related U.S. Application Data
(60) Provisional application No. 63/303,279, filed on Jan. 26, 2022.

(51) Int. Cl. G09G 5/10; G06V 40/13

(52) U.S. Cl. CPC G09G 5/10; G06V 40/1318; G09G 2320/0646; G09G 2320/0686; G09G 2320/0247

(57) ABSTRACT

This document describes systems and techniques directed at minimizing display flickering during biometric authentication. In aspects, an electronic device having a display panel and a biometric authentication system, such as an under-display fingerprint sensor (UDFPS), includes a display manager configured to implement a localized high-luminance region on the display panel during biometric authentication. The display manager may be further configured to implement a standby state at one or more intervals during the biometric authentication, so as to reduce a number of signal modulations which may otherwise be perceived as a display flickering. In so doing, the display manager selectively entering a standby state during a biometric authentication can minimize display flickering, affording a better user experience.

### RELATED APPLICATION

This application claims priority under 35 U.S.C. § 119(e) to U.S. Provisional Patent Application 63/303,279, filed on Jan. 26, 2022 which is incorporated herein by reference in its entirety.

### SUMMARY

This document describes systems and techniques directed at minimizing display flickering during biometric authentication. In aspects, an electronic device having a display panel and a biometric authentication system, such as an under-display fingerprint sensor (UDFPS), includes a display manager configured to implement a localized high-luminance region on the display panel during biometric authentication. The display manager is further configured to implement a standby mode at one or more intervals during the biometric authentication to reduce a number of signal modulations, which may otherwise be perceived as a display flickering. In so doing, the display manager selectively enters a standby mode during a biometric authentication, which can minimize display flickering and afford a better user experience.

This Summary is provided to introduce simplified of concepts systems and techniques for minimizing display flickering during biometric authentication, the concepts of which are further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of systems and techniques directed at minimizing display flickering during biometric authentication are described in this document with reference to the following drawings:

FIG. 1 illustrates an example environment having a user and an electronic device;

FIG. 2 illustrates an example implementation that includes the example electronic device of FIG. 1, which is configured to minimize display flickering during biometric authentication;

FIG. 3 illustrates a partial top plan view and a partial, cross-sectional view of the electronic device having an under-display fingerprint sensor;

FIG. 4 illustrates a high-luminance region on the OLED display;

FIG. 5 illustrates two graphs illustrating an emission cycle waveform having pulse-width modulation and pulse-amplitude modulation;

FIG. 6 illustrates two graphs implementing a standby mode to reduce a number of signal modulations; and

FIG. 7 illustrates an example method for minimizing display flickering during biometric authentication.

The same numbers are used throughout the Drawings to reference like features and components.

### DETAILED DESCRIPTION

Overview

This document describes systems and techniques directed at minimizing display flickering during biometric authentication. In aspects, an electronic device having a display panel and a biometric authentication system, such as an under-display fingerprint sensor, includes a display manager configured to implement a standby mode at one or more intervals during biometric authentication to reduce a number of signal modulations that may otherwise be perceived as a display flickering.

Many electronic devices (e.g., smartphones, desktops, smartwatches) include display panels, often simply referred to as displays or screens. Such display panels frequently rely on organic light-emitting diode (OLED) technology, such as an active-matrix OLED (AMOLED) display, utilizing tens of thousands of pixel circuits each having their own organic light-emitting diode (“pixel”). Electronic devices can cause different pixels within display panels to illuminate at different intensities and wavelengths, effective to produce on-screen content (e.g., images). By exploiting a feature of the human eye and brain referred to as persistence of vision (e.g., retinal persistence), a display panel can redraw on-screen content at predetermined frequencies (“refresh rate”) to save power and give an illusion of on-screen content as images in motion (e.g., video). For example, a display panel configured to operate at a 120 hertz (Hz) refresh rate can redraw on-screen content 120 times per second. OLED displays, in comparison to other display technologies, include many advantages such as quick refresh rates, small display response times, and low power consumption. These benefits make OLED displays well-suited for electronic devices and are, therefore, highly prized by users for their display image-quality.

Further, electronic devices having OLED displays can be configured to include one or more biometric recognition systems disposed underneath an OLED display. For instance, to provide a high screen-to-body ratio and, thereby, preserve space on a display side of an electronic device, manufacturers may embed under-display fingerprint sensors (UDFPS) beneath an OLED display. Users may then be afforded the opportunity to provide user input (e.g., a finger having a fingerprint) to, for example, authenticate themselves to one or more applications or an operating system implemented on the electronic device. Users authenticating themselves to an electronic device using one or more biometrics is referred to herein as biometric authentication.

Devices configured to perform biometric authentication using an UDFPS may utilize pixels in the OLED display to illuminate a user input. Due to a low transmissibility of light from an external environment through the display panel to the UDFPS, capturing a well-illuminated user input can be difficult. To this end, a display manager controlling an OLED display of an electronic device can be configured to implement a localized high-luminance region (“high-luminance region”) on a portion of a display panel to better illuminate user input. The luminosity of the high-luminance region, expressed in candela per square meter (“nit”), may be hundreds to thousands of nits greater in luminosity than other portions of the display panel (“background region”) during biometric authentication. For example, the display manager can implement a high-luminance region having a luminosity of 200 to 1200 or more nits and a background region (e.g., a non-high-luminance region) having a luminosity of 0 to 200 nits. Through such techniques, the display manager implementing a high-luminance region may facilitate UDFPS sensing of reflected light from user input (e.g., their finger press).

However, in some circumstances, an OLED display operating at a low luminance with a display manager implementing a high-luminance region may manifest faintly perceivable flickering (“display flickering”). Electronic-device users who generally appreciate OLED displays for their quality may desire not to see such display flickering.

Example Device

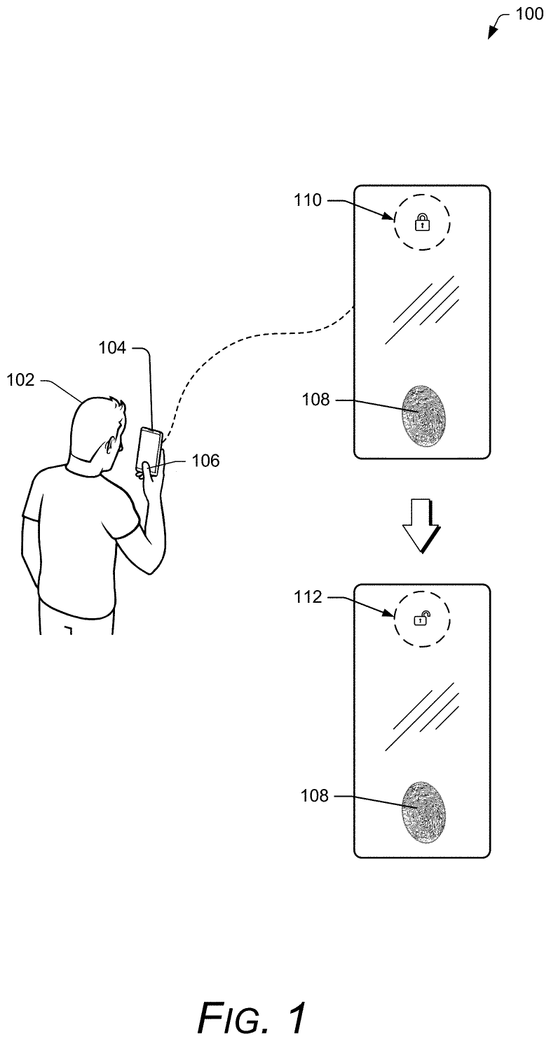

FIG. 1 illustrates an example implementation 100 of an electronic device configured to minimize display flickering during biometric authentication. As illustrated, a user 102 is holding an electronic device 104 with a thumb 106 on a display of the electronic device. The user 102 may provide user input, including the thumb 104 having a fingerprint 108, to the electronic device for biometric authentication. The biometric authentication system can be configured to capture an image (“verify image”) of the fingerprint 106. Upon capturing the verify image, the biometric authentication system can compare the verify image to an enrolled image (e.g., an authorized fingerprint). Based on the comparison, the biometric authentication system can instruct, for example, an operating system of the electronic device to change states from a locked state 110 to an unlocked state 112, or to remain in the locked state 110 (not illustrated).

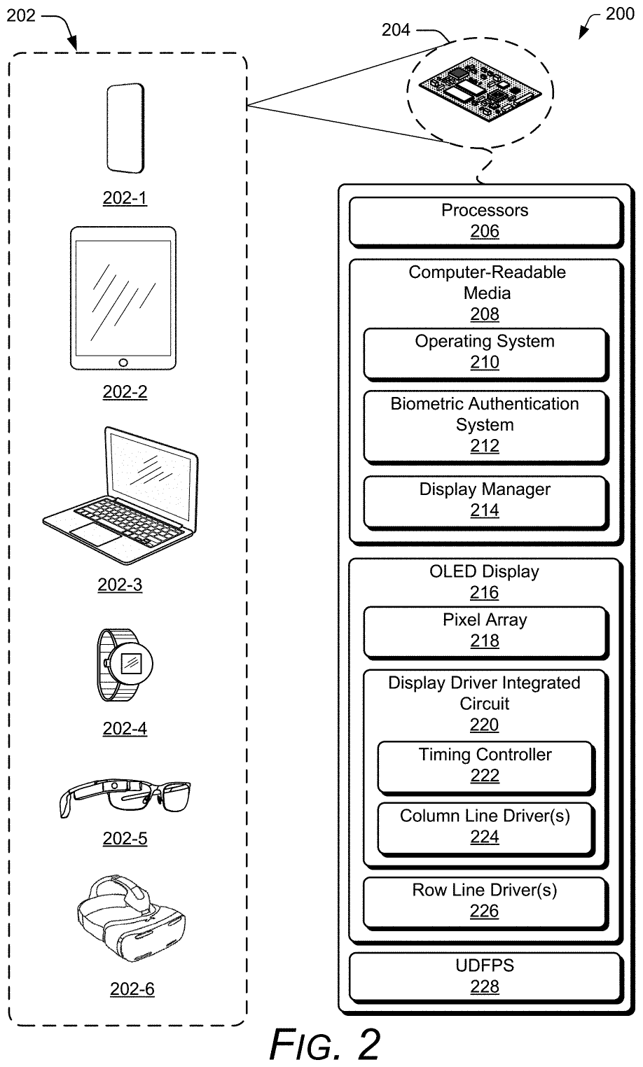

In more detail, FIG. 2 illustrates an example implementation 200 that includes the example electronic device (electronic device 104) of FIG. 1, which is capable of minimizing display flickering during biometric authentication. The electronic device 202 is illustrated with a variety of example devices, including consumer electronic devices. As non-limiting examples, the electronic device 202 can be a mobile phone 202-1, a tablet device 202-2, a laptop computer 202-3, a computerized watch 202-4, smart glasses 202-5, virtual-reality (VR) goggles 202-6, and the like. Note that the electronic device 202 can be wearable, non-wearable but mobile, or relatively immobile (e.g., desktops, appliances). The electronic device 202 may include additional components and interfaces omitted from FIG. 2 for the sake of clarity.

As illustrated, the electronic device 202 includes a printed circuit board assembly 204 (PCBA 204) on which components and interconnects of the electronic device 202 are embodied. In implementations, the PCBA 204 may include multiple printed circuit boards operably coupled together via, for example, electrical wiring. Alternatively or additionally, components of the electronic device 202 can be embodied on other substrates, such as flexible circuit material or other insulative material. Generally, electrical components and electromechanical components of the electronic device 202 are assembled onto a printed circuit board (PCB) to form the PCBA 204. Various components of the PCBA 204 (e.g., processors and memories) are then programmed and tested to verify the correct function of the PCBA 204. The PCBA 204 is connected to or assembled with other parts of the electronic device 202 into a housing.

As illustrated, the PCBA 204 includes one or more processors 206 and computer-readable media 208. The processors 206 may include any suitable single-core or multi-core processor. The processors 206 may be configured to execute instructions or commands stored within computer-readable media 208 including an operating system 210, a biometric authentication system 212, and a display manager 214. For example, the processor(s) 206 may perform specific computational tasks of the operating system directed at controlling the creation and display of on-screen content on a display. In another example, the processor(s) 206 may execute instructions of the operating system to implement a display refresh rate of 120 Hz. The computer-readable media 208 may include one or more non-transitory storage devices such as a random access memory, hard drive, solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other, but still cooperate and/or interact with each other.

The electronic device 202 further includes an OLED display 216. Although illustrated as OLED display 216, the electronic device may include or be implemented as any of a variety of displays. The OLED display 216 includes a pixel array 218 of pixel circuits and a display driver integrated circuit 220 (DDIC 220). The DDIC 220 may include a timing controller 222 and column line driver(s) 224. The column line driver(s) 224 may include, as a non-limiting example, a data-line driver. The OLED display may further include row line driver(s) 226. The row line driver(s) 226 may include, as non-limiting examples, gate-line drivers, scan-line drivers, and/or emission-control drivers.

The timing controller 222 provides interfacing functionality between the processor(s) 206 and the drivers (e.g., column line driver(s) 224, row line driver(s) 226) of the OLED display 216. The timing controller 110 generally accepts commands and data from the processor(s) 206, generates signals with appropriate voltage, current, timing, and demultiplexing, and transmits the signals to the drivers to enable the OLED display 216 to present the desired image.

The drivers may transmit time-variant and amplitude-variant signals (e.g., voltage signals, current signals) to control the pixel array 218. For example, a data-line driver transmits signals containing voltage data to the pixel array 218 to control the luminance of an organic light-emitting diode. A scan-line driver transmits a signal to enable or disable an organic light-emitting diode to receive the data voltage from the data-line driver. An emission-control driver supplies an emission-control signal to the pixel array 218. Together, the drivers control the pixel array 218 to generate light to create an image on the OLED display 216.

The PCBA 204 may further include one or more sensors disposed anywhere on or in the electronic device. The sensors can include any of a variety of sensors, such as an audio sensor (e.g., a microphone), a touch-input sensor (e.g., a touchscreen), an image-capture device (e.g., a camera, video-camera), proximity sensors (e.g., capacitive sensors), an ambient light sensor (e.g., photodetector), and/or an UDFPS 228. The UDFPS 228 can be implemented as an optical UDFPS or as an ultrasonic UDFPS. The UDFPS 228 can be disposed within a housing of the electronic device 202, embedded underneath the OLED display 216. In implementations, the PCBA 204 can include more than one UDFPS 228.

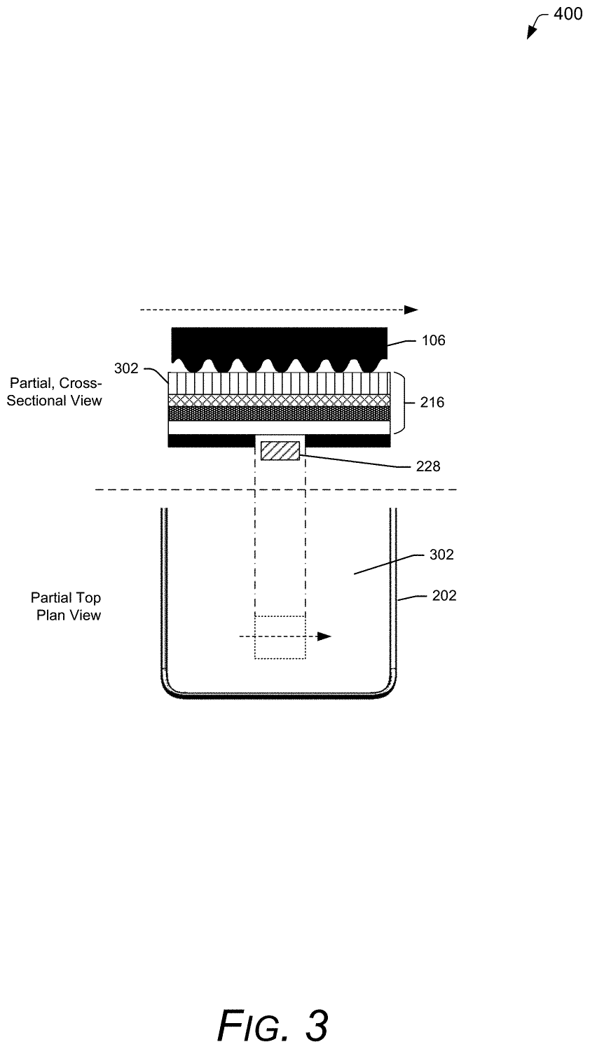

FIG. 3 illustrates a partial top plan view and a partial, cross-sectional view of the electronic device 202 having the UDFPS 228. As illustrated in the partial top plan view, at a bottom half of the electronic device 202, a UDFPS 228 may be embedded underneath the OLED display 216. The OLED display 216 may be implemented as a display panel stack including a cover layer 302 and a display module. In implementations, the cover layer 302 may be any transparent substrate composed of a variety of materials, including plastic or glass. The display module may include one or more of a polarizer film, a display panel, a metallic layer, optical adhesive (OCA), a polymer layer, and a back cover. The UDFPS 228 may be attached (e.g., bonded, laminated) to the underside of the OLED display 216. Although the UDFPS 228 is illustrated as shaped substantially rectangular, the UDFPS 228 may be any of a variety of three-dimensional shapes. The UDFPS 228 is configured to capture reflected light of a user input (thumb 106) transmitted through the OLED display 216.

In some cases, during fingerprint authentication, an intensity of the reflected light of a user input may be too low to be transmitted through the OLED display 216 and sensed by the UDFPS 228. For example, the OLED display 216 may have a visible light transmission (VLT) (e.g., the measurement of light transmission through a given medium) of less than 5%, resulting in sub-optimal imaging capturing of the user input on the part of the UDFPS 228. As a result, the display manager 214 may instruct processor(s) 206 to implement a local high-brightness mode to increase a luminosity in a localized region of the OLED display (“high-luminance region”).

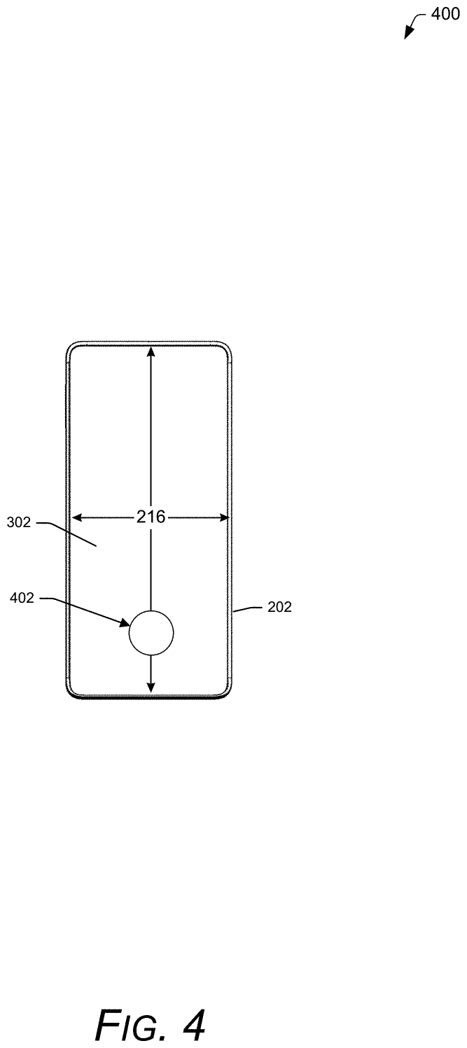

FIG. 4 illustrates a high-luminance region 402 on the OLED display 216. As illustrated, the electronic device 202 includes cover layer 302 of an OLED display 216. The display manager 214 can direct the DDIC 220 to increase the luminosity of individual organic light-emitting diodes in the high-luminance region 402 of the OLED display 216. In some cases, the organic light-emitting diodes may illuminate several hundred nits more than a background region surrounding the high-luminance region 402. The display manager 214, directing the DDIC 220 to implement a high-luminance region 402, may intensify reflected light from user input, facilitating UDFPS sensing. As a result, the UDFPS can capture a well-illuminated image of the user input.

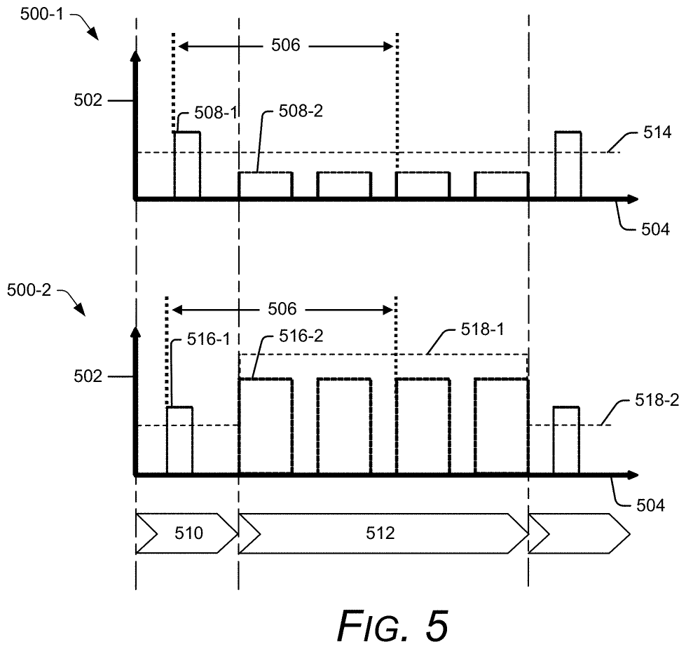

The display manager 214 can implement the high-luminance region 402 through any of a variety of techniques, including pulse-width modulation and/or pulse-amplitude modulation. Consider FIG. 5, which illustrates two graphs 500 (e.g., graph 500-1, graph 500-2), each having an emission cycle waveform, illustrating techniques of pulse-width modulation and pulse-amplitude modulation. Each of the two graphs 500 illustrate pixel luminance (e.g., y-axis 502) versus time (e.g., x-axis 504), and further illustrate one display frame time 506. Graph 500-1 illustrates a graphical representation of pixel luminance versus time for a background region on the OLED display 216. Graph 500-2 illustrates a graphical representation of pixel luminance versus time for a high-luminance region 402 on the OLED display 216.

Graph 500-1 further illustrates a single emission-cycle waveform having at least one emission cycle 508 (e.g., emission-cycle 508-1, emission-cycle 508-2) with one or more states (e.g., a high state, a low state) for the background region. Each of the emission-cycles 508 may have states varying in amplitude. In implementations, the display manager 214 may direct the DDIC 220 to implement a pixel luminance (e.g., a perceived pixel luminance 514) using one or more emission-cycles 508 with differing amplitudes and/or duty cycles. As an example, the display manager 214 directs the DDIC 220 to implement a pixel luminance of 80 nits (e.g., perceived pixel luminance 514) using a first emission-cycle 508-1 having a duty cycle of 40%. The first emission cycle 508-1 can be implemented while in a first mode 510. In a second mode 512, the display manager 214 may direct the DDIC 220 to produce a second emission-cycle 508-2 having a duty cycle of 80% with a reduced amplitude using pulse-width modulation and pulse-amplitude modulation, respectively, to implement a pixel luminance of 80 nits. In both the first mode 510 and the second mode 512, the display manager 214 can direct the DDIC 220 to produce two emission-cycles 508 with differing duty cycles and amplitudes to implement an identical, perceived pixel luminance 514.

Graph 500-2 further illustrates multiple emission-cycles 516 (e.g., emission-cycle 516-1, emission-cycle 516-2) for the high-luminance region. In implementations, the display manager 214 may direct the DDIC 220 to implement a pixel luminance (e.g., a perceived pixel luminance) using one or more emission-cycles 516. As an example, the display manager 214 directs the DDIC 220 to implement a pixel luminance of 80 nits (e.g., perceived pixel luminance 518-2) using a first emission-cycle waveform 516-1 having a duty cycle of 40%. The first emission cycle 516-1 can be implemented while in the first mode 510. In a second mode 512, the display manager 214 may direct the DDIC 220 to produce a second emission-cycle 516-2 having a duty cycle of 80% with an increased amplitude using pulse-width modulation and pulse-amplitude modulation, respectively, to implement a high pixel luminance for the biometric authentication (e.g., a pixel luminance 518-1 of 800 nits). In both the first mode 510 and the second mode 512, the display manager 214 can direct the DDIC 220 to produce two emission-cycles 516 with varying duty cycles and amplitudes to implement two different perceived pixel luminance's 518 (e.g., pixel luminance 518-1, pixel luminance 518-2). Using the disclosed techniques, including pulse-width modulation and pulse-amplitude modulation, the display manager 214 can selectively increase, decrease, and/or maintain a pixel luminance of one or more regions of the OLED display 216 from a first pixel luminance to a second pixel luminance.

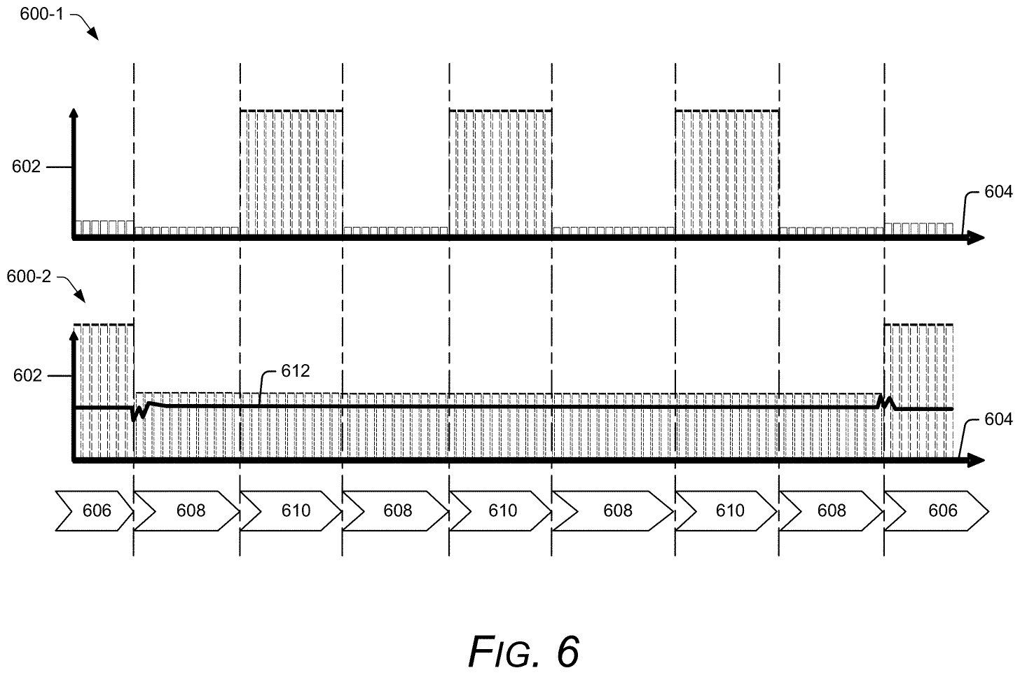

In aspects, the display manager 214 may further be configured to implement a standby mode to reduce a number of signal modulations, which in some instances can cause a user to perceive a display flickering. Consider FIG. 6, which illustrates two graphs 600 (e.g., graph 600-1, graph 600-2) implementing a standby mode to reduce a number of signal modulations. Each of the two graphs 600 illustrate pixel luminance (e.g., y-axis 602) versus time (e.g., x-axis 604). Graph 600-1 illustrates a graphical representation of pixel luminance versus time for a high-luminance region 402 on the OLED display 216. Graph 600-2 illustrates a graphical representation of pixel luminance versus time for a background region on the OLED display.

The two graphs both illustrate an emission-cycle waveform having varying duty cycles and amplitudes. In implementations, the display manager 214 may transition between modes. Based on the mode, the display manager 214 may direct the DDIC 220 to adjust display driving conditions through one or more of pulse-width modulation and pulse-amplitude modulation. As an example, upon activation of a biometric authentication system, the display manager 214 can transition from a first mode 606 to a standby mode 608. To implement a high-luminance region, the display manager 214 can transition from the standby mode 608 to a high-luminance mode 610. Each of the modes may configure the display manager 214 to direct the DDIC 202 to adjust display driving conditions through one or more of pulse-width modulation and pulse-amplitude modulation. In an implementation, transitioning between the standby mode 608 and the high-luminance mode 610 may enable the display manager 214 to implement a consistent display-driving condition by adjusting either the duty cycle or the amplitude for a section of the emission-cycle waveform using pulse-width modulation or pulse-amplitude modulation, respectively. For example, FIG. 6 illustrates a configuration of the standby mode 608 and the high-luminance mode 610 enabling the display manager 214 to implement a consistent driving conditions by only performing pulse-amplitude modulation when transitioning between the two modes. Whereas, when transitioning to the standby mode 608 from the first mode 606 the display manager 214 may implement both pulse-amplitude modulation and pulse-width modulation. Through such a technique, during biometric authentication, a number of signal modulations can be reduced to minimize a display flickering.

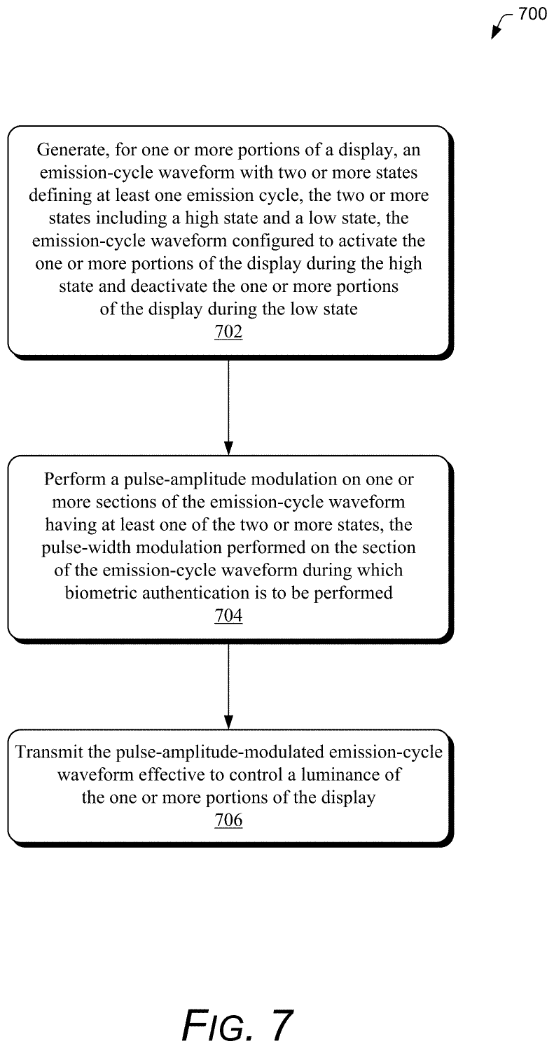

FIG. 7 illustrates an example method 700 of the display manager 214 directing the DDIC 220. At step 702, an emission-cycle waveform with two or more states defining at least one emission cycle, is generated. The two or more states including a high state and a low state, the emission-cycle waveform configured to activate the one or more portions of the display during the high state and deactivate the one or more portions of the display during the low state. For example, at step 702 the display manager 214 directs the DDIC 220 to generate one or more emission-cycle waveforms with two or more states (e.g., a high state, a low state) to activate one or more portion of the display.

At step 704, a pulse-amplitude modulation on one or more sections of the emission-cycle waveform having at least one of the two or more states is performed. The pulse-width modulation is performed on the section of the emission-cycle waveform during which biometric authentication is to be performed. For example, at step 704 the display manager 214 directs the DDIC 220 to perform a pulse-amplitude modulation on the emission-cycle waveform during at least one of the two or more modes, the at least one of the two or more modes being a period in which biometric authentication is performed.

At step 706, the pulse-amplitude-modulated emission-cycle waveform is transmitted effective to control a luminance of the one or more portions of the display. For example, at step 706 the display manager 214 directs the DDIC 220 to transmit the emission-cycle waveform to control a luminance of the OLED display 216.

What is claimed is:

1. A computer-implemented method comprising:
generating, for one or more portions of a display, an emission-cycle waveform with two or more states defining at least one emission cycle, the two or more states including a high state and a low state, the emission-cycle waveform configured to activate the one or more portions of the display during the high state and deactivate the one or more portions of the display during the low state;
performing a pulse-amplitude modulation on one or more sections of the emission-cycle waveform having at least one of the two or more states, the pulse-amplitude modulation performed on the section of the emission-cycle waveform during which biometric authentication is to be performed; and
transmitting the pulse-amplitude-modulated emission-cycle waveform effective to control a luminance of the one or more portions of the display.

2. The computer-implemented method of claim 1, wherein transmitting the pulse-amplitude-modulated emission-cycle waveform effective to control the luminance of the one or more portions of the display causes the one or more portions of the display to implement a high-luminance region.

3. The computer-implemented method of claim 2, wherein the pulse-amplitude-modulated emission-cycle waveform includes multiple sections of the one or more sections effective to implement the high-luminance region for each of the multiple sections.

4. The computer-implemented method of claim 1, further comprising:
performing pulse-width modulation during at least one other section of the one or more sections, the other section in which biometric authentication is not performed; and
transmitting the pulse-width-modulated emission-cycle waveform effective to control a second luminance of at least one portion of the one or more portions of the display, the transmitting effective to implement a non-high-luminance region.

5. The computer-implemented method of claim 3, wherein performing the pulse-width modulation and performing the pulse-amplitude modulation are performed simultaneously.

6. The computer-implemented method of claim 1, wherein biometric authentication repeats multiple times during the one or more sections.
